(19) United States
(12) Patent Application Publication
(10) Pub. No.: US 2002/0167274 A1
(43) Pub. Date: Nov. 14, 2002

(54) Plasma screen

(76) Inventor: Matthias Wendt, Wurselen (DE)

Correspondence Address: U.S. Philips Corporation, 580 White Plains Road, Tarrytown, NY, 10591, US

(21) Appl. No.: 10/122,795

(22) Filed: Apr. 12, 2002

(30) Foreign Application Priority Data
Apr. 12, 2001 (DE) 10118286.4

(51) Int. Cl. H01J 17/49

(52) U.S. Cl. 313/582

(57) ABSTRACT

The present invention relates to a system with a plasma screen (1)

which between a transparent disc (9) turned away from the viewer and a rear wall (8) has cells for the generation of pixels,

which has electronic circuits for the supply of power to the cells during the luminous phases and

which has a two-dimensional feedback electrode on the outside of the rear wall, which electrode is connected to the electronic circuits and which is provided for carrying the feedback currents between the electronic circuits and the cells.

The present invention relates to a system with a plasma screen.

Currently available television sets with plasma screens require a substantial number of components for the screening of electromagnetic fields. For example, a solid aluminum or metal housing along with a metal-coated screen front are necessary to meet the legal requirements on electromagnetic compatibility. These screening measures are, on the one hand, costly, and on the other increase the weight of the sets.

EP 0 986 086 A2 describes a plasma screen that has means to reduce electromagnetic radiation. For this purpose ground electrodes run across the rear of the plasma screen, and these can be grounded and run parallel to the addressing electrodes. When currents flow through the addressing electrodes, image currents are generated in the ground electrodes which are superimposed on the currents of the addressing electrodes and therefore compensate them.

The object of this invention is to further improve the circuits and the feeders for driving the plasma screen so that the emission of electromagnetic radiation is reduced and additional screening measures become unnecessary.

In accordance with the invention this object is achieved by a system with a plasma screen

which between a transparent disc turned away from the viewer and a rear wall has cells for the generation of pixels,

which has electronic circuits for the supply of power to the cells during the luminous phases and

which has a two-dimensional feedback electrode on the outside of the rear wall, which electrode is connected to the electronic circuits and which is provided for carrying the feedback currents between the electronic circuits and the cells.

The advantage of such a system is that the emission of electromagnetic radiation during the luminous phases of the plasma screen is significantly reduced. Since the currents are much larger during the luminous phase than, for example, the relatively weak currents in the addressing electrodes, they require particular attention for the screening. In order to compensate for the strong currents, the reverse currents generated during the luminous planes of individual cells of the plasma screen are carried by the feedback electrode on the rear of the plasma screen to the boards of the driver stages. As a result, the reverse currents flow very close to the currents to the front electrodes of the plasma screen. Because of the small distance between the reverse currents and the currents in the front electrodes there is a good magnetic coupling between these currents. As a result of this the electromagnetic fields of the reverse currents and the front currents compensate each other very well. Seen from the top of the plasma screen, due to the small distance between the feedback electrode and the front electrodes, the radiating surface spreading between the feedback electrode and front electrodes is also reduced.

The embodiment as claimed in claim 2 offers the further advantage that, additionally, the reverse currents of the electrodes located at the top and bottom edges of the plasma screen are superimposed on the currents in the front electrodes. In this way also the currents flowing in the edge areas of the plasma screen are compensated in optimum fashion.

With the embodiment as claimed in claim 3 the current paths between the boards of the driver stages and the feedback electrode can be shortened, which further reduces the emission of electromagnetic radiation. To this end the current connection of the feedback electrode is spread across the full width of the board, so that also in the board area the reverse currents flow behind the currents of the front electrodes and are not concentrated to any one connection point. In order that the currents in the electrodes at the top and bottom edges of the plasma screen are also properly compensated in the board area, the boards are built across the full width of the plasma screen.

If the feedback electrode is located directly on the rear of the plasma screen, as in claim 4, then the radiating surface, seen from above between the feedback electrode and the front electrode, is at a minimum, resulting in a particularly low emission of electromagnetic radiation.

With the embodiment as claimed in claim 5 the radiating surface seen from above can again be reduced considerably in top view, since the connection between the boards of the driver stages is now moved from the inside to the outside of the plasma screen. The path of the reverse currents to the boards is actually increased somewhat, but the radiating surface is much smaller. With a suitable form of the feedback electrode, it is possible to keep the radiating surface small, even for boards that are not built across the full width of the plasma screen. In doing so the flexible connections to the boards must match with the form of the feedback electrode.

The embodiments as claimed in claims 6 and 7 ensure a low-cost manufacture of the feedback electrode because a conductive film or coating can be applied without any problem during the manufacture of the plasma screen. This is particularly important in view of the large area of the feedback electrode that in the best case covers the entire back surface of the plasma screen.

The embodiment as claimed in claim 8 is associated with an additional screening effect. Since the feedback electrode is conductive and thus has low electrical resistance, it is suitable for screening electromagnetic radiation emitted frontally from the plasma screen, if it is applied to the front of the plasma screen. In this way the screening front panel, that has previously been necessary but is very costly and heavy, can be spared. Of course, the feedback electrode must then be made from a transparent material that absorbs the minimum possible amount of light from the light cells of the plasma screen.

The embodiment as claimed in claim 9 minimizes the radiating surfaces between the connection to the front electrodes and the connections to the feedback electrode. This common connection to the front electrodes and to the feedback electrode also simplifies the manufacturing process, since the connections to the front electrodes and the feedback electrode can be manufactured in a single working cycle. To this end the connection has e.g. a double-sided flex foil design wherein one side has printed conductors creating the connections to the front electrodes and the other side connects the feedback electrode.

The present invention is described in more detail using examples of embodiment and Figures in which:

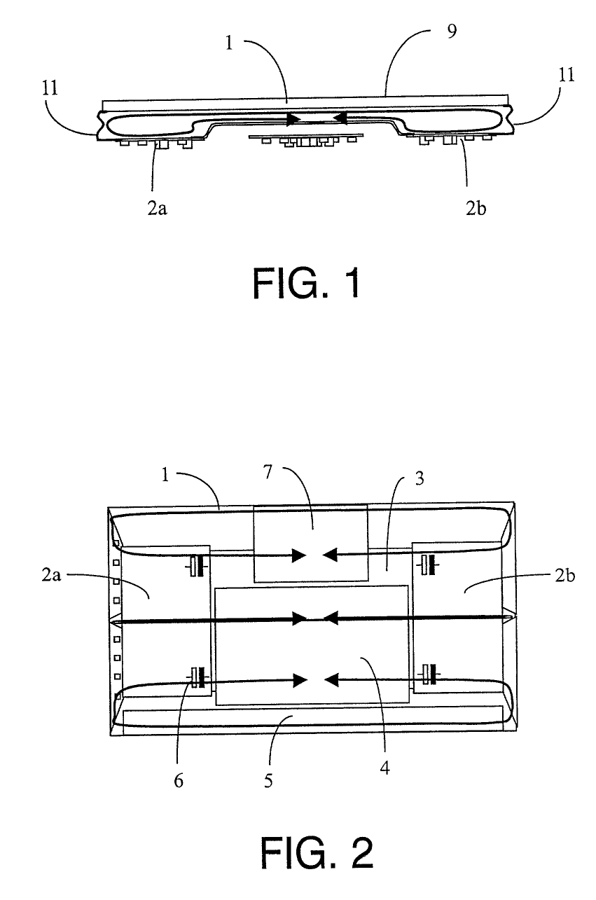

FIG. 1 shows a conventional plasma screen in top view from above,

FIG. 2 shows the rear of a conventional plasma screen showing the current flows,

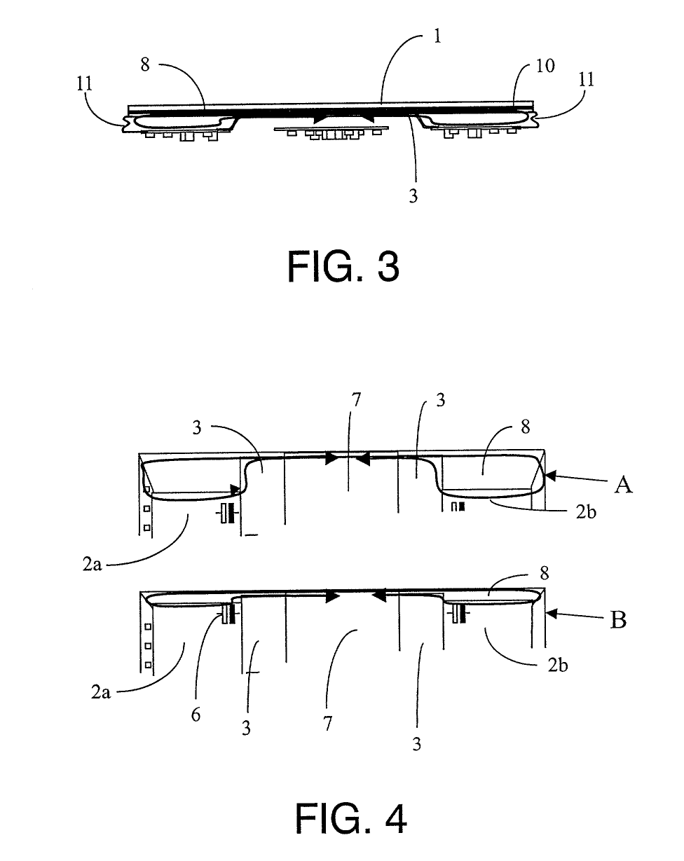

FIG. 3 shows a plasma screen in accordance with the invention with reduced radiating surface in top view from above,

FIG. 4 shows the rear of a plasma screen in accordance with the invention with a further reduced radiating surface,

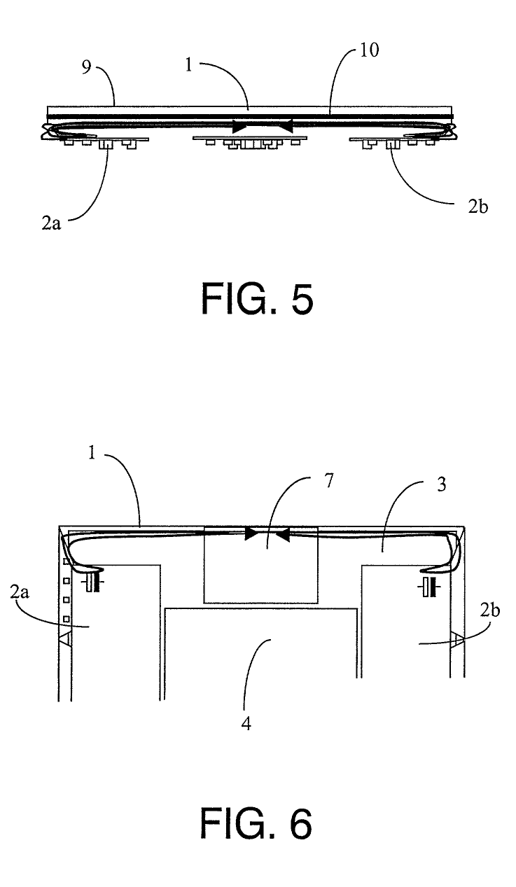

FIG. 5 shows a plasma screen in accordance with the invention with a particularly small radiating surface in top view from above and

FIG. 6 shows the rear of a plasma screen in accordance with the invention with a particularly small radiating surface.

As can be seen from FIGS. 1 and 2, a system in accordance with the invention comprises above all the plasma screen 1 itself, on the rear 8 of which a feedback electrode 3 is present that connects the plasma screen 1 with electronic circuits on boards 2a, 2b of the driver stages via feeders 11, which driver stages are used for triggering the picture elements of the plasma screen 1. To shorten the current paths the circuits can also be arranged on a shared board instead of being arranged on two separate boards 2a, 2b.

The feedback electrode 3 extends over a large area across the full width and length of the plasma screen 1, where stripped areas of the rear wall 8 may remain uncovered in the edge areas if this is desirable from a production engineering point of view. This has little influence on the screening effect of the feedback electrode 3. The boards 2a, 2b drive the plasma screen 1 and cause the desired cells between a front face 9 and the rear wall 8 to light up. For this purpose the boards draw their current from a supply module 7, for example a switched-mode power supply. The picture elements that are to light up are selected by means of further circuits 4, 5. In addition so-called buffer capacitors 6 are present.

When a picture element is triggered, the picture element lights up, and currents flow through feeders 11 across the front electrodes 10 to the luminous cells and back to the boards 2a, 2b via the feedback electrode 3. The front electrodes 10 run in horizontal direction and carry relatively strong and above all high-frequency currents. Furthermore, electromagnetic waves are radiated from the current-carrying connections 3, 10, 11. The current paths of a conventional plasma screen 1 are also shown in FIGS. 1 and 2 by thick black lines. The high currents and the associated reverse currents cover a surface area, where a large surface area stands for high electromagnetic radiation. Therefore, with the present invention these areas are reduced so that the electromagnetic fields of the incoming currents and the outgoing currents are compensated to the greatest possible extent.

In a first embodiment as shown in FIGS. 3 and 4 the radiating surfaces are reduced in that the feedback electrode 3 is mounted directly on the rear 8 of the plasma screen 1. The feedback electrode 3 is moreover preferably a conductive coating or film. The currents in the feedback electrode 3 and the currents in the front electrodes 10 are therefore compensated and the area that is covered by the currents is reduced. In FIG. 4B the boards 2a, 2b reach almost as far as the top and bottom edge of the rear 8 of the plasma screen 1. Thus the reverse currents in the edge area of the plasma screen I also run largely behind the currents of the front electrodes 10. The driver boards 2a, 2b are moreover mounted as close as possible to the rear 8 and thus in the vicinity of the feedback electrode 3 of the plasma screen 1. This reduces, seen from above, the surface that is covered by the currents. The feedback electrode 3, instead of being a large one-piece area, can also be designed in strips, covering the rear 8 of the plasma screen 1. This may be desirable from a production-engineering point of view and has little influence on the current carried in the feedback electrode 3.

In FIGS. 5 and 6 the boards 2a, 2b are connected on outer edges of the sides of the plasma screen 1 to the feedback electrode 3. This reduces the radiating areas in the top view from above. This type of contact arrangement ensures that the connections 11 from the boards 2a, 2b to the feedback electrode 3 and the connections 11 from the boards 2a, 2b to the front electrodes 10 run directly on top of or next to each other. The best solutions for the connections 11 has proven to be printed conductors in the form of a flat cable, which on the one side carries the current to the electrodes 10 and on the other carries the reverse current from the feedback electrode. Thus in the connections 11 and in the area of the boards 2a, 2b the currents are compensated in optimum fashion and cover the radiating surfaces only to an extremely limited extent. With such connections 11 it is also possible to move the feedback electrode 3 to the front of the plasma screen, since such a front feedback electrode 3 just like the front electrodes 10 can only be contacted on the outer edges of the plasma screen 1. In this case the feedback electrode 3 comprises a low-impedance, transparent coating which carries the reverse currents. Since the feedback electrode 3 is now positioned directly in front of the electrodes 10, the current compensation is even better and in addition a further screening effect of the feedback electrode 3 evolves, which effect screens the currents from the electrodes 10 to the front. Thus the otherwise normal screening glass pane 9 on the front of the plasma screen 1 can possibly be dispensed with and replaced by a thin plastic film.

1. A system with a plasma screen (1),
which between a transparent disc turned away from the viewer and a rear wall has cells for the generation of pixels,
which has electronic circuits for the supply of power to the cells during the luminous phases and
which has a two-dimensional feedback electrode on the outside of the rear wall, which electrode is connected to the electronic circuits and which is provided for carrying the feedback currents between the electronic circuits and the cells.

2. A system as claimed in claim 1, characterized in that the electronic circuits are arranged on boards (2a, 2b) which essentially extend across the width or length of the feedback electrode (3).

3. A system as claimed in claim 2, characterized in the contact arrangement of the boards (2a, 2b) with the feedback electrode (3) essentially extends across the width and length of the feedback electrode (3).

4. A system as claimed in claim 1, characterized in that the feedback electrode (3) is positioned directly on the outside of the rear wall (8).

5. A system as claimed in claim 2, characterized in that the feedback electrode (3) is arranged on the outside of the rear wall (8) from one outer edge to the opposing outer edge of the plasma screen (1) and from the outer edges back to the boards (2a, 2b).

6. A system as claimed in claim 4, characterized in that the feedback electrode (3) is a conductive film.

7. A system as claimed in claim 4, characterized in that the feedback electrode (3) is a conductive coating.

8. A system as claimed in claim 1, characterized in that the feedback electrode (3) is applied to the transparent front face (9) as a conductive coating.

9. A system as claimed in claim 2, characterized in that the electrical connection of the feedback electrode (3) to the boards (2a, 2b) and the electrical connection of the front electrodes to the boards (2a, 2b) are realized by conductor tracks on a common substrate (11).

10. A television or monitor with a plasma screen (1),
which between a transparent disc turned away from the viewer and a rear wall has cells for the generation of pixels,
which has electronic circuits for the supply of power to the cells during the luminous phases and
which has a two-dimensional feedback electrode on the outside of the rear wall, which electrode is connected to the electronic circuits and which is provided for carrying the feedback currents between the electronic circuits and the cells.
